(19) United States
(12) Patent Application Publication
(10) Pub. No.: US 2019/0090693 A1
(43) Pub. Date: Mar. 28, 2019

(54) ROTATORY MATERIAL PROCESSING SYSTEM

(71) Applicant: Or Czerninski, Givatayim (IL)

(72) Inventor: Or Czerninski, Givatayim (IL)

(21) Appl. No.: 15/713,659

(22) Filed: Sep. 24, 2017

(51) Int. Cl. A47J 43/04

(52) U.S. Cl. CPC A47J 43/04

(57) ABSTRACT

Disclosed herein a rotatory material processing system for processing a plurality of edible material contained therein using at least two material processing blade set adapted to spin in opposite direction; comprises of a material processing unit; and a spinning unit. The material processing unit further comprises of a material processing unit lid protruding a first material processing blade set at inner surface and a strainer size adjust shield adapted for controlling size of the processed plurality of edible material contained. The spinning unit further comprises of a second material processing blade set extended between the first material processing blade set and the strainer size adjust shield, adapted to spin in opposite direction of first material processing blade set for processing the plurality of edible material contained therein; a material storage unit and a material storage unit lid.

### FIELD OF THE INVENTION

The present application generally relates to the field of portable material processing systems. Particularly, the application provides a rotatory material processing system. More particularly, the application provides a rotatory material processing system for processing a plurality of edible material contained therein using at least two material processing blade set adapted to spin in opposite direction.

### BACKGROUND

Material processing is generally defined as a series of steps used in manufacture of raw materials into finished goods. The material processing may involve a plurality of mechanical, chemical or other processes to bring raw material in consumable form. The recent development and consequent implement of advance material processing technology have certainly reduced human efforts along with the achievement of production efficiency.

Prior art illustrates development of various systems, devices, tools, techniques, and methods to process material at an industrial scale to produce finished goods in large quantities. However, developing tools, techniques, methods for processing material at user level is still considered to be one of the challenges in the technical domain. A user level material processing may include but not limited to grinding, cutting, shredding, and chopping of material such as edible plant material and alike for human consumption.

Prior art literature illustrates a variety of system for user level material processing. However most of the portable material processing systems essentially require external power or continuous human efforts to operate such material processing systems. Prior art literature fails to disclose portable material processing system which could be actuated by spinning the material processing systems once. In addition, none of the prior art literature discloses utilizing the resultant momentum generated by the relative spinning of various components of material processing system for processing material contained therein.

In view of the above mentioned background, it is evident that, there is a need for a rotatory material processing system, which could process a plurality of edible material, contained therein using at least two material processing blade set adapted to spin in opposite direction. There is also a need for a rotatory material processing system, wherein momentum generated by the relative spinning of at least two material processing blade set which could process a plurality of edible material contained therein. A rotatory material processing system is desired.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a rotatory material processing system.

Another objective is to provide a rotatory material processing system which could process a plurality of edible material contained therein using at least two material processing blade set adapted to spin in opposite direction.

Another objective is to provide a rotatory material processing system, wherein momentum generated by the relative spinning of at least two material processing blade set could process a plurality of edible material contained therein.

In accordance with one embodiment of the present invention, a rotatory material processing system (100) for processing a plurality of edible material contained therein using at least two material processing blade set adapted to spin in opposite direction is provided. The rotatory material processing system (100) comprises of at least one material processing unit (102) and a spinning unit (104). The at least one material processing unit (102) further comprises of a material processing unit lid (106) protruding a first material processing blade set at inner surface adapted to spin for processing the plurality of edible material contained therein; and a strainer size adjust shield (108) adapted for controlling size of the processed plurality of edible material contained therein by rotating within the at least one material processing unit (102). The spinning unit (104) further comprises of a second material processing blade set (110) extended between the first material processing blade set protruded at inner surface of the material processing unit lid (106) and the strainer size adjust shield (108), adapted to spin in opposite direction of first material processing blade set protruded at inner surface of the material processing unit lid (106) for processing the plurality of edible material contained therein; a material storage unit (112) adapted for storing the processed plurality of edible material; and a material storage unit lid (114) adapted for covering the material storage unit (112).

The above configuration is provided for a rotatory material processing system but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 is a diagram illustrating top view of a rotatory material processing system, in accordance with one embodiment of the present invention;

FIG. 2 is a diagram illustrating side view of a rotatory material processing system, in accordance with one embodiment of the present invention;

FIG. 3 is a diagram illustrating perspective view of a rotatory material processing system, in accordance with one embodiment of the present invention;

FIG. 4 is a diagram illustrating side detailed view of a rotatory material processing system, in accordance with one embodiment of the present invention; and

FIG. 5 is a diagram illustrating exploded view of a rotatory material processing system, in accordance with one embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In accordance with one embodiment of the present invention, a rotatory material processing system (100) for processing a plurality of edible material contained therein using at least two material processing blade set adapted to spin in opposite direction is provided.

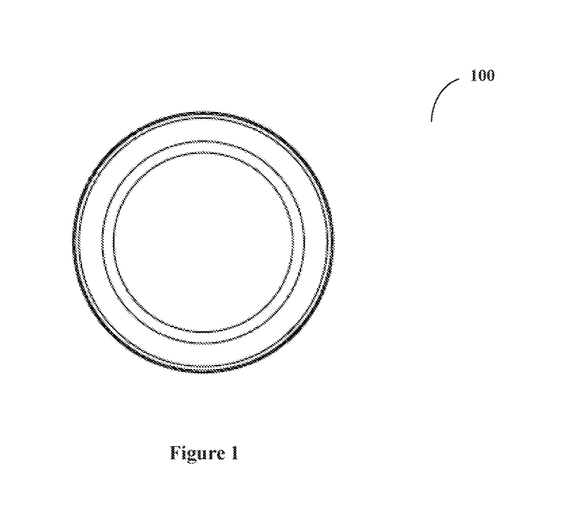

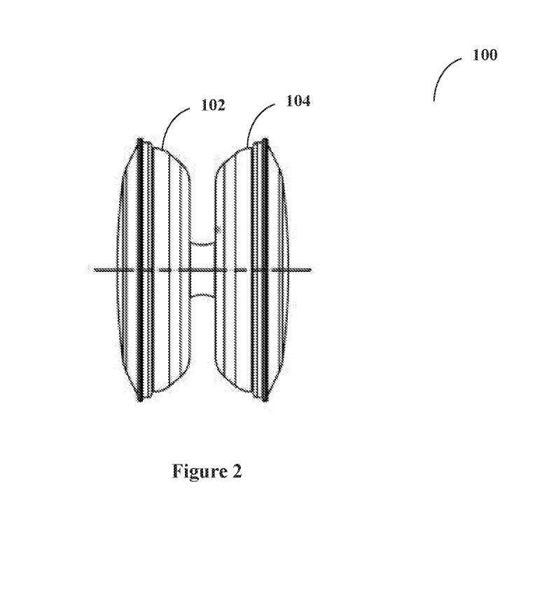

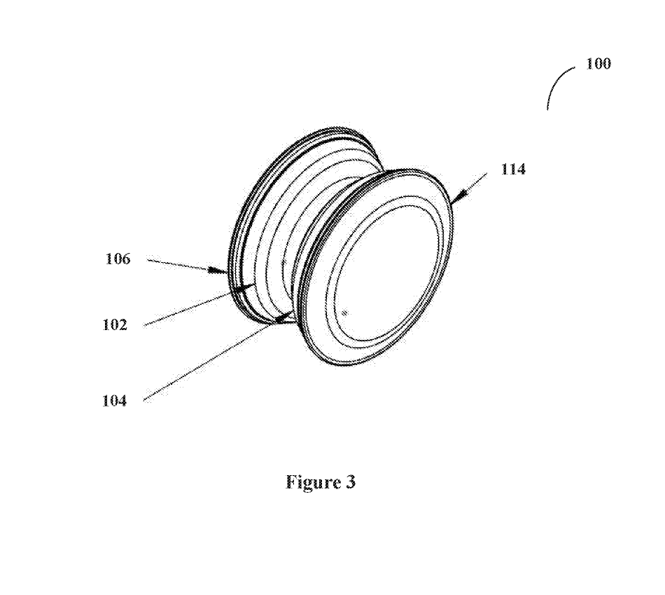

Referring to the FIG. 1 is illustrating top view of a rotatory material processing system; FIG. 2 is illustrating side view of a rotatory material processing system; and FIG. 3 is illustrating perspective view of a rotatory material processing system, in accordance with one embodiment of the present invention.

In accordance with one embodiment of the present invention, the rotatory material processing system (100) for processing a plurality of edible material contained therein using at least two material processing blade set adapted to spin in opposite direction is provided. The plurality of edible material contained therein the rotatory material processing system (100) for processing may be selected from a group comprising but not limited to herb, dried herb, tobacco, other plant material, ground leaves and alike. The processing of the plurality of edible material contained therein the rotatory material processing system (100) may be selected from a group comprising but not limited to grinding, cutting, shredding, and chopping.

In accordance with one embodiment of the present invention, the rotatory material processing system (100) comprises of at least one material processing unit (102) and a spinning unit (104). The at least one material processing unit (102) further comprises of a material processing unit lid (106) protruding a first material processing blade set at inner surface adapted to spin for processing the plurality of edible material contained therein. The spinning unit (104) further comprises of a second material processing blade set (110) (not shown in FIGS. 1; 2; and 3) extended between the first material processing blade set protruded at inner surface of the material processing unit lid (106) and a strainer size adjust shield (108) (not shown in FIGS. 1; 2; and 3), adapted to spin in opposite direction of first material processing blade set protruded at inner surface of the material processing unit lid (106) for processing the plurality of edible material contained therein; and a material storage unit (112) (not shown in FIGS. 1; 2; and 3) adapted for storing the processed plurality of edible material; and a material storage unit lid (114) adapted for covering the material storage unit (112) (not shown in FIGS. 1; 2; and 3). The plurality of edible material may include but not limited to any material suitable for human consumption via direct or indirect consumption methods including but not limited to eating, smoking etc.

In accordance with one embodiment of the present invention, the processing of the plurality of edible material contained therein the rotatory material processing system (100) may occur using opposite direction spin of the first material processing blade set protruded at inner surface of the material processing unit lid (106) and a second material processing blade set (110) (not shown in FIGS. 1; 2; and 3) extended within the at least one material processing unit (102). The opposite direction spin of the first material processing blade set protruded at inner surface of the material processing unit lid (106) and the second material processing blade set (110) (not shown in FIGS. 1; 2; and 3) extended within the at least one material processing unit (102) may occur due to momentum generated by the relative spinning of the at least one material processing unit (102) and the spinning unit (104). The momentum generated by the relative spinning of the at least one material processing unit (102) and the spinning unit (104) and corresponding opposite direction spin of the first material processing blade set protruded at inner surface of the material processing unit lid (106) and a second material processing blade set (110) (not shown in FIGS. 1; 2; and 3) extended within the at least one material processing unit (102) may be generated by a string attached to the axle (116) connecting the at least one material processing unit (102) and the spinning unit (104). The first material processing blade set protruded at inner surface of the material processing unit lid (106) and the second material processing blade set (110) (not shown in FIGS. 1; 2; and 3) may be manufactured from a metal, which may be hard, stiff and also thin at the same time which may be enough to avoid metal flex during the momentum generated by the relative spinning of the at least one material processing unit (102) and the spinning unit (104) and corresponding opposite direction spin of the first material processing blade set protruded at inner surface of the material processing unit lid (106) and a second material processing blade set (110) (not shown in FIGS. 1; 2; and 3) extended within the at least one material processing unit (102).

In accordance with an exemplary embodiment of the present invention, the processing of the plurality of edible material contained therein the rotatory material processing system (100) may occur using spin of the first material processing blade set protruded at inner surface of the material processing unit lid (106) exclusively; spin of the second material processing blade set (110) (not shown in FIGS. 1; 2; and 3) extended within the at least one material processing unit (102) exclusively; relative spinning of the first material processing blade set protruded at inner surface of the material processing unit lid (106) and the second material processing blade set (110) (not shown in FIGS. 1; 2; and 3) extended within the at least one material processing unit (102). The processing of the plurality of edible material contained therein the rotatory material processing system (100) may occur using spin of either the first material processing blade set protruded at inner surface of the material processing unit lid (106) or the second material processing blade set (110) (not shown in FIGS. 1; 2; and 3) extended within the at least one material processing unit (102). The opposite direction spin of the first material processing blade set protruded at inner surface of the material processing unit lid (106) and the second material processing blade set (110) (not shown in FIGS. 1; 2; and 3) extended within the at least one material processing unit (102) or spin of the first material processing blade set protruded at inner surface of the material processing unit lid (106) against the static second material processing blade set (110) (not shown in FIGS. 1; 2; and 3) extended within the at least one material processing unit (102) may occur due to momentum generated by the relative spinning of the at least one material processing unit (102) and the spinning unit (104).

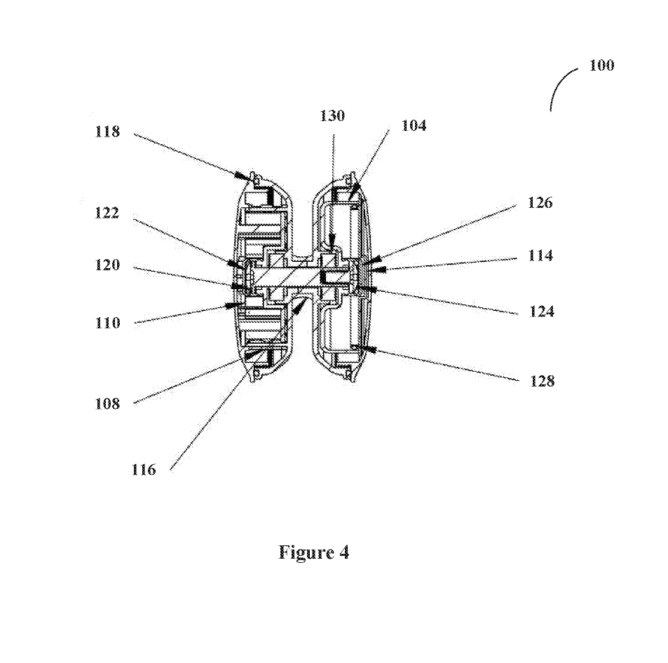

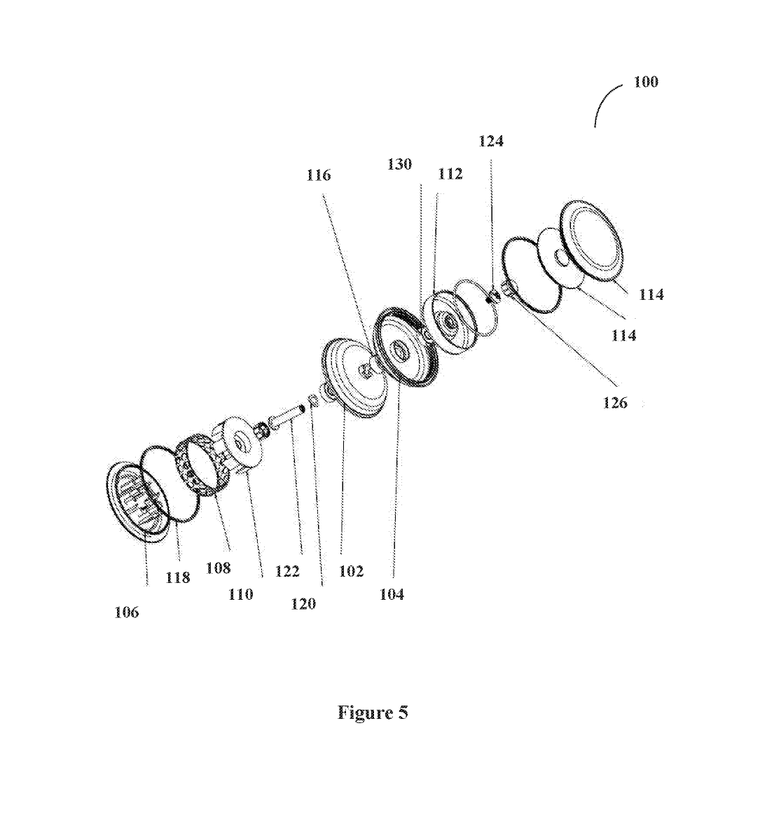

Referring to the FIG. 4 is illustrating side detailed view of a rotatory material processing system; and FIG. 5 is illustrating exploded view of a rotatory material processing system, in accordance with one embodiment of the present invention.

In accordance with one embodiment of the present invention, the rotatory material processing system (100) comprises of at least one material processing unit (102) and a spinning unit (104). The at least one material processing unit (102) may further comprise of a material processing unit lid (106); a strainer size adjust shield (108); an x profile O-ring (118); and a single wave washer (120). The spinning unit (104) may further comprise of a second material processing blade set (110); a material storage unit (112); a material storage unit lid (114); a binding post barrel (122); a binding post screw (124); a screw head cover (126); an O-ring (128); and a pair of bearing (130). The rotatory material processing system (100) and corresponding components may be manufactured from a material selected from a group comprising but not limited to metal and plastic. The plastic may be hard plastic such as polycarbonate, and metal may include not limited to Aluminum, 6061 which may be a precipitation-hardened aluminium alloy, carbon and titanium.

In accordance with one embodiment of the present invention, the rotatory material processing system (100) may further comprises of an axle (116) passing through the center of and connecting the at least one material processing unit (102) and the spinning unit (104). The processing of the plurality of edible material contained therein the rotatory material processing system (100) may occur using opposite direction spin of the first material processing blade set protruded at inner surface of the material processing unit lid (106) and the second material processing blade set (110) extended within the at least one material processing unit (102). The opposite direction spin of the first material processing blade set protruded at inner surface of the material processing unit lid (106) and the second material processing blade set (110) extended within the at least one material processing unit (102) may occur due to momentum generated by the relative spinning of the at least one material processing unit (102) and the spinning unit (104). The momentum generated by the relative spinning of the at least one material processing unit (102) and the spinning unit (104) and corresponding opposite direction spin of the first material processing blade set protruded at inner surface of the material processing unit lid (106) and the second material processing blade set (110) extended within the at least one material processing unit (102) may be generated by a string attached to the axle (116) connecting the at least one material processing unit (102) and the spinning unit (104).

In accordance with one embodiment of the present invention, the at least one material processing unit (102) further comprises of the material processing unit lid (106) and a strainer size adjust shield (108). The material processing unit lid (106) may be protruding the first material processing blade set at inner surface. The material processing unit lid (106) may be adapted to spin for processing the plurality of edible material contained therein. The strainer size adjust shield (108) may be adapted for controlling size of the processed plurality of edible material contained therein by rotating within the at least one material processing unit (102). The strainer size adjust shield (108) may slide over the at least one material processing unit (102) and may allow the strainer size adjust shield (108) to be rotated, which may dictate the size of opening for the strainer size adjust shield (108).

In accordance with an alternate embodiment of the present invention, the rotatory material processing system (100) may comprise of two material processing unit (102) connected with each other through the axle (116). Each of the two material processing unit (102) may further comprise of corresponding material processing unit lid (106); and the strainer size adjust shield (108). The processing of the plurality of edible material contained therein each of the rotatory material processing system (100) may occur using opposite direction spin of each of the first material processing blade set protruded at inner surface of each of the material processing unit lid (106) and the second material processing blade set (110) extended within each of the at least one material processing unit (102).

In accordance with an alternate embodiment of the present invention, the processing of the plurality of edible material contained therein the rotatory material processing system (100) may occur using opposite direction spin of the first material processing blade set protruded at inner surface of the material processing unit lid (106) and the second material processing blade set (110) extended within the at least one material processing unit (102). The processed plurality of edible material contained therein the rotatory material processing system (100) may be pushed outward due to the opposite direction spin of the first material processing blade set protruded at inner surface of the material processing unit lid (106) and the second material processing blade set (110) extended within the at least one material processing unit (102). The size of opening on the strainer size adjust shield (108) may allow a predetermined size of the processed plurality of edible material into the material storage unit (112). The material storage unit (112) may keep the processed plurality of edible material with the air tight material storage unit lid (114). In accordance with an alternate embodiment of the present invention, the material storage unit (112) may be of variable size or may not be present in the spinning unit (104). The inertia of the rotatory material processing system (100) may push the processed plurality of edible material contained therein to outward, such as in the material storage unit (112)

In accordance with one embodiment of the present invention, the at least one material processing unit (102) may further comprises of an x profile O-ring (118) adapted to provide fiction seal to the material processing unit lid (106) and prevent spiral failure. The at least one material processing unit (102) may further comprises of a single wave washer (120) adapted for providing low strength fastening of the at least one material processing unit (102) and the spinning unit (104) through the axle (116).

In accordance with one embodiment of the present invention, the spinning unit (104) further comprises of the second material processing blade set (110) extended between the first material processing blade set protruded at inner surface of the material processing unit lid (106) and the strainer size adjust shield (108), adapted to spin in opposite direction of first material processing blade set protruded at inner surface of the material processing unit lid (106) for processing the plurality of edible material contained therein; a material storage unit (112) adapted for storing the processed plurality of edible material; and a material storage unit lid (114) adapted for covering the material storage unit (112). The material storage unit (112) of the spinning unit (104) may be adapted to act as a counter weight to keep the free linear movement of the spinning unit (104) around the axle (116). The spinning unit (104) may further comprises of the binding post (122) fixed with the binding post screw (124) and the screw head cover (126), serving as a connector between the at least one material processing unit (102) and the spinning unit (104). The spinning unit (104) may further comprises of the O-ring (128) adapted to provide fiction seal to the material processing unit lid (106). The spinning unit (104) may further comprises of the pair of bearing (130) adapted for providing free linear movement of the spinning unit (104) around the axle (116).

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

What is claimed is:

1. A rotatory material processing system (100) for processing a plurality of edible material contained therein using at least two material processing blade set adapted to spin in opposite direction; the rotatory material processing system (100) comprises of:
a. at least one material processing unit (102) further comprises of:
a material processing unit lid (106) protruding a first material processing blade set at inner surface adapted to spin for processing the plurality of edible material contained therein; and
a strainer size adjust shield (108) adapted for controlling size of the processed plurality of edible material contained therein by rotating within the at least one material processing unit (102); and
b. a spinning unit (104) further comprises of:
a second material processing blade set (110) extended between the first material processing blade set protruded at inner surface of the material processing unit lid (106) and the strainer size adjust shield (108), adapted to spin in opposite direction of first material processing blade set protruded at inner surface of the material processing unit lid (106) for processing the plurality of edible material contained therein;
a material storage unit (112) adapted for storing the processed plurality of edible material; and
a material storage unit lid (114) adapted for covering the material storage unit (112).

2. The rotatory material processing system (100) as claimed in claim 1, wherein the processing of the plurality of edible material contained therein the rotatory material processing system (100) is selected from a group comprising grinding, cutting, shredding, and chopping.

3. The rotatory material processing system (100) as claimed in claim 1, wherein the processing of the plurality of edible material contained therein the rotatory material processing system (100) occurs using opposite direction spin of the first material processing blade set protruded at inner surface of the material processing unit lid (106) and the second material processing blade set (110) extended within the at least one material processing unit (102).

4. The rotatory material processing system (100) as claimed in claim 1, wherein the opposite direction spin of the first material processing blade set protruded at inner surface of the material processing unit lid (106) and the second material processing blade set (110) extended within the at least one material processing unit (102) occurs due to momentum generated by the relative spinning of the at least one material processing unit (102) and the spinning unit (104).

5. The rotatory material processing system (100) as claimed in claim 1, further comprises of an axle (116) passing through the center of and connecting the at least one material processing unit (102) and the spinning unit (104).

6. The rotatory material processing system (100) as claimed in claim 1, wherein the at least one material processing unit (102) further comprises of an x profile O-ring (118) adapted to provide fiction seal to the material processing unit lid (106) and prevent spiral failure.

7. The rotatory material processing system (100) as claimed in claim 1, wherein the at least one material processing unit (102) further comprises of a single wave washer (120) adapted for providing low strength fastening of the at least one material processing unit (102) and the spinning unit (104) through the axle (116).

8. The rotatory material processing system (100) as claimed in claim 1, wherein the spinning unit (104) further comprises of a binding post (122) fixed with a binding post screw (124) and a screw head cover (126), serving as a connector between the at least one material processing unit (102) and the spinning unit (104).

9. The rotatory material processing system (100) as claimed in claim 1, wherein the spinning unit (104) further comprises of an O-ring (128) adapted to provide fiction seal to the material processing unit lid (106).

10. The rotatory material processing system (100) as claimed in claim 1, wherein the spinning unit (104) further comprises of a pair of bearing (130) adapted for providing free linear movement of the spinning unit (104) around the axle (116).

11. The rotatory material processing system (100) as claimed in claim 1, wherein the material storage unit (112) of the spinning unit (104) adapted to act as a counter weight to keep the free linear movement of the spinning unit (104) around the axle (116).
